(19) United States
(12) Patent Application Publication
(10) Pub. No.: US 2003/0001013 A1
(43) Pub. Date: Jan. 2, 2003

(54) Information recording medium, information processing method, information processing apparatus, and program

(75) Inventor: Yoshikazu Akamine, Kitatsuru-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/155,687

(22) Filed: May 23, 2002

(30) Foreign Application Priority Data
Jun. 27, 2001 (JP) 2001-195222
Apr. 23, 2002 (JP) 2002-120799

(51) Int. Cl. G06K 7/10; G06K 7/14

(52) U.S. Cl. 235/454

(57) ABSTRACT

A script file containing contents for controlling files, folders, applications, devices, and other objects is recorded as an optically readable coded image on an information recording medium together with the heading of each genre, a symbolic illustration representing each control content, and an accurate explanation of the control content by texts. When the operator reads a desired coded image by an information processing apparatus, a decoder decodes the script file of the coded image. A scripting host application loads and executes the script file. The script file controls various application programs such as a Web browser and mailer, files, folders, devices, and other objects.

### CROSS-REFERENCE TO RELATED APPLICATIONS

This application is based upon and claims the benefit of priority from the prior Japanese Patent Applications No. 2001-195222, filed Jun. 27, 2001; and No. 2002-120799, filed Apr. 23, 2002, the entire contents of both of which are incorporated herein by reference.

### BACKGROUND OF THE INVENTION

1. Field of the Invention

The present invention relates to an information recording medium having a portion which bears a coded image such as an optically readable dot pattern obtained by encoding digital information. The present invention also relates to an information processing method of reading the coded image from the information recording medium and processing the image, an information processing apparatus for reading the coded image from the information recording medium and processing the image, and a program which causes a program-compatible device such as a computer to operate as the information processing apparatus.

2. Description of the Related Art

Various image recording methods and image recording apparatuses have conventionally been proposed. According to these apparatuses and methods, visually recognizable images directly readable by a human eye, such as texts (or characters), symbols, figures, patterns, photographic images, and computer graphic images, and optically readable speech-coded images including one- or two-dimensional barcodes obtained by performing encoding processing including compression, modulation, and error correction coding for audio data are printed on a sheet-like printing medium such as a paper sheet or film.

Such methods and apparatuses are disclosed in, e.g., Jpn. Pat. Appln. KOKAI Publication No. 60-244146, U.S. Pat. No. 5,896,403, U.S. Pat. No. Re. 36,589, and U.S. Pat. No. 6,134,695.

According to these references, speech is printed on a sheet surface. Visually recognizable images and speech can be integrated on the sheet surface. The speech-coded image is read by a dedicated reader. The user can easily listen to the speech on the spot while seeing the visually recognizable image.

Of these references, U.S. Pat No. 5,896,403, U.S. Pat. No. Re. 36,589, and U.S. Pat. No. 6,134,695 disclose methods of encoding data such as speech into a dot code serving as a speech-coded image which can be optically read with ease by manual scanning, and printing the dot code together with a visually recognizable image on a sheet-like printing medium such as a paper sheet.

FIG. 1 shows the physical format structure of such a dot code.

A dot code 1 is constituted by two-dimensionally arraying a plurality of blocks 2 adjacent to each other. Each block 2 is formed from a data dot pattern 3, markers 4, and a block address pattern 5. The data dot pattern 3 is a portion where data segmented into blocks of audio data to be recorded exist in a predetermined two-dimensional array as dot images of black or white dots corresponding to data values “1” or “0” (in many cases, “white” as the ground color of a printing medium is directly read). The markers 4 are used to detect reference points for reading dots (data dots) within the data dot pattern 3. The markers 4 have a predetermined number of successive black dots set at the four corners of each block. The block address pattern 5 is laid out between markers so as to identify a plurality of different blocks in read. The block address pattern 5 contains an error detection/correction code. Note that vertical and horizontal lines in FIG. 1 conveniently represent the positions of respective dots. White dots correspond to the ground color of a sheet surface itself. In FIG. 1, a block address value is written within a square representing a block for descriptive convenience, but no numerical value is actually recorded.

This dot code 1 allows reconstructing the entire original data from data included in respective blocks as far as an address assigned to each block 2 can be detected for each block together with data dots included in the block even if the whole dot code 1 is larger than an image pickup field 6 of the reader, in other words, the dot code 1 cannot be sensed at one shot by the reader. Data such as speech can be actually printed on a sheet surface and can be easily read even by manual scanning.

Such a dot code is not limited to the above-described audio data, but can contain so-called multimedia information including video data, text data, and the like in an optically readable format.

An example of a device which processes such multimedia information is a personal computer (to be simply referred to as a PC hereinafter).

Therefore, it is conceivable that multimedia information recorded as a dot code is transmitted to the PC and processed on the PC.

However, association between the dot code and the PC has not been fully discussed yet, and several problems exist.

For example, to reconstruct multimedia information recorded as a dot code, the PC must possess all control programs, parameters, application data files, and the like which are assumed to be used.

The operator must start up a reconstruction application program.

Considering the above situation, the present applicant has proposed as U.S. patent application Ser. No. 09/722,942 an information recording medium which allows reconstructing read multimedia information from a dot code even if the PC does not possess all control programs, parameters, application data files, and the like which are assumed to be used, an information processing method and information processing apparatus capable of reconstructing information even if the operator does not start up a reconstruction application program, and a program recording medium which stores a program for causing the computer to operate as the information processing apparatus.

In the PC use environment such as Microsoft® Windows®, Mac OS™, or LINUX®, advanced Web browser software such as Microsoft® Internet Explorer or Netscape® Navigator is distributed free of charge by the Internet or a CD-ROM. In selling and shipping PCs, the Web browser software is generally installed. Further, Web browser software is being installed as standard equipment in information home appliances such as a net TV and set-top BOX, and portable information terminals such as a recent cellular telephone and PDA (Personal Digital Assistants). As for the content description language of the Web browser software, an HTML (HyperText Markup Language) script is used as a standard language except for cellular telephones which use a CHTML (Compact HyperText Markup Language) script or HDML (Handheld Device Markup Language) script. In the future, contents will be described by a common XHTML (the Extensible HyperText Markup Language) script.

The Web browser such as Microsoft® Internet Explorer or Netscape® Navigator includes Java™ Virtual Machine as standard equipment. By reading a Java™ class file together with the script file, the same file can be commonly used on different computers regardless of the OS such as Windows®, Mac OS™, LINUX®, or UNIX®. Java™ Virtual Machine is being installed not only in PCs having different OSs but also in cellular telephones, PDAs, and some stay-at-home type information terminals. An environment where the same program complying with Java™ can be commonly used on each platform regardless of the OS or device is becoming available.

The script language means a program language other than a general-purpose program language such as a C language or assembler program. The script language adopts a programming scheme which executes a source program in an interpreter form. Most of script languages are programs which execute a source file as a text file. An engine for operating such a program exists at any portion on a machine.

For example, as for Windows®, an active scripting host referred to Windows Scripting Host is installed as standard equipment in Windows® 98 or later. Windows Scripting Host loads a file described by a script language such as Visual Basic® Scripting Edition (to be simply referred to as VBScript hereinafter) or JScript® and operates as an interpreter, thereby being able to control an OS, device, file, or application.

Recently, a scripting host application irrespective of the OS exists on every OS. Scripting host applications can load the same script to control OSs, devices, files, or applications even on different OSs. For example, as for a script language Tcl/Tk, scripting host applications are prepared for respective OSs such as Windows®, Mac OS™, UNIX®, LINUX®, and BSD. By installing this scripting host application in advance, script files of the same description commonly run on every OS. Perl, Ruby, and Python are also script languages which can be used commonly between many OSs.

An active script assumed to be loaded into an interpreter such as the above-mentioned scripting host application, particularly the active scripting host is displayed as an object such as a filed icon on a desktop. In this case, as far as the extension of the script file is registered in correspondence with the activation of a proper scripting host application in, e.g., the Windows® environment, the script file is loaded into the scripting host application only by double-clicking the icon by the operator. The script program is executed in a way described in the script file. This enables various objects such as copying, movement, and deletion of a designated file or folder, editing of file contents, control and information acquisition of an application program or internal/external device, and interactive control between these objects. As one of the objects, the settings of a registry which holds pieces of setting information about the OS, application, and hardware environment can be easily changed.

More specifically, as for application control as one of the objects, various routine works are described as script files such that information designated by a Web browser is collected, and data using spreadsheet software are accumulated and graphed. By double-clicking the icon, a target work is completed to shorten the working time of the operator. If a work is automatically executed on the background, the operator can spend a time on another work without any consciousness of the cumbersome work.

For example, the registry of Windows® can be changed by, e.g., operating a GUI (Graphical User Interface) accessory to an OS or application by the operator, and indirectly, safely changing the registry file. However, many setting contents can only be changed by directly editing the registry file using an application program such as a registry editing tool. For example, repetitively installing and uninstalling programs leaves data unnecessary for general use of the operator in the registry. These data can only be deleted by directly editing the registry file. Directly editing the registry file is, however, risky for an operator who does not have expert knowledge about PC, and may destruct a system or file. If a change method of directly editing registry information is correctly described using a script, even an operator who does not have expert knowledge about PC can instantaneously obtain intended settings only by double-clicking the filed icon of the described method.

In a company, a computer expert or system manager prepares for script files complying with respective purposes. These script files are loaded into an operator's machine via e-mail or by a magnetic disk or the like. The operator can double-click the file to attain the target result. Many convenient files for respective purposes may fill a desktop 7 with icons 8, as shown in FIG. 2. Subfolders may be prepared to classify and store files for each purpose. However, the operator can recognize the function by only a file name 9 displayed below the icon 8. The file name 9 cannot clearly express distinct operation differences. The operation becomes complicated, and it is difficult to search for a file which realizes target operation. If many icons 8 exist, the operator may double-click a wrong icon with a mouse or the like to activate unwanted operation at high probability while searching for a target file. This impairs the original convenience.

As another problem, not all offices or home can ensure an expert who creates a script in accordance with the purpose of each operator. In recent years, scenes with the use of computers have abruptly increased at home and in various fields along with the spread of the Internet and e-commerce. For example, computers are daily used in various service industries such as public agencies, schools, medical/welfare facilities, retail/wholesale trades, insurance/financial business, food service industry, and transport industry which do not require any computer expert usually. At the same time, higher working efficiency and utility are required for each case. In many cases, most of operators do not have knowledge about scripts or do not have a programmer who can easily create a script in accordance with each demand. At homes where many PC beginners exist, it must be more difficult to ensure such an expert. Demands arise for an original script file function capable of realizing settings which are difficult for a PC beginner, and automatic control of files or applications only by performing a simple operation such as double-click.

### BRIEF SUMMARY OF THE INVENTION

The present invention has been made in consideration of the above situation, and has as its object to provide an information recording medium, information processing method, information processing apparatus, and program which allow the user to easily designate an object associated with an information processing apparatus for processing digital information, and to process or control the object.

According to a first aspect of the present invention, there is provided an information recording medium comprising:

a portion where a visually recognizable image directly read by a human eye is recorded; and

a portion where digital information is recorded as an optically readable coded image obtained by encoding the digital information,

wherein the digital information contains a script to designate an object associated with an information processing apparatus which processes digital information obtained by optically reading and decoding the coded image and to perform at least one of processing and control.

According to a second aspect of the present invention, there is provided an information processing method comprising:

obtaining a script by optically reading an optically readable coded image from an information recording medium which includes a portion where digital information is recorded as the optically readable coded image obtained by encoding the digital information, the digital information containing the script to designate an object associated with an information processing apparatus which processes digital information obtained by optically reading and decoding the coded image and to perform at least one of processing and control; and

analyzing the obtained script and performing the at least one of processing and control.

According to a third aspect of the present invention, there is provided an information processing apparatus comprising:

a reader which optically reads an optically readable coded image from an information recording medium which includes a portion where digital information is recorded as the optically readable coded image obtained by encoding the digital information, the digital information containing a script to designate an object associated with the information processing apparatus which processes digital information obtained by optically reading and decoding the coded image and to perform at least one of processing and control;

a decoder which obtains an original script from the coded image read by the reader; and

an information processor which analyzes the script obtained by the decoder and performs at least one of the processing and control.

According to a fourth aspect of the present invention, there is provided a program to cause a computer to realize following functions, comprising:

a function of obtaining a script by optically reading an optically readable coded image from an information recording medium which includes a portion where digital information is recorded as the optically readable coded image obtained by encoding the digital information, the digital information containing the script to designate an object associated with an information processing apparatus which processes digital information obtained by optically reading and decoding the coded image and to perform at least one of processing and control; and

a function of analyzing the obtained script and performing the at least one of processing and control.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention and, together with the general description given above and the detailed description of the embodiments given below, serve to explain the principles of the invention.

FIG. 1 is a view showing the physical format structure of a dot code as an example of an optically readable coded image;

FIG. 2 is a view showing a display example for explaining conventional problems;

FIG. 3 is a block diagram showing a cellular telephone with a Web browser function to which an information processing apparatus according to the first embodiment is applied;

FIG. 4 is a view showing the logic format structure of an optically readable coded image recorded on an information recording medium according to the first embodiment of the present invention;

FIG. 5 is a block diagram showing an information processing apparatus according to the first embodiment;

FIG. 6 is a view showing the information recording medium according to the first embodiment;

FIG. 7 is a view showing the logic format structure of a coded image recorded on an information recording medium according to the second embodiment of the present invention;

FIG. 8 is a block diagram showing an information processing apparatus according to the second embodiment;

FIG. 9 is a view for explaining MS-Agent;

FIG. 10 is a view showing the logic format structure of a coded image recorded on an information recording medium according to the third embodiment of the present invention;

FIG. 11 is a block diagram showing an information processing apparatus according to the third embodiment;

FIG. 12 is a view showing the hyperlink relationship between HTML files;

FIG. 13 is a view showing the logic format structure of a coded image recorded on an information recording medium according to the fourth embodiment of the present invention;

FIG. 14 is a block diagram showing an information processing apparatus according to the fourth embodiment;

FIG. 15 is a flow chart showing the operation of the information processing apparatus according to the fourth embodiment;

FIG. 16 is a view showing a display example according to the fourth embodiment;

FIG. 17 is a view showing another display example according to the fourth embodiment;

FIG. 18A is a view showing the logic format structure of the first coded image recorded on an information recording medium according to the fifth embodiment of the present invention;

FIG. 18B is a view showing the logic format structure of the second coded image recorded on the information recording medium according to the fifth embodiment of the present invention;

FIG. 19 is a view showing the information recording medium according to the fifth embodiment;

FIG. 20 is a view showing a Web browser display screen;

FIG. 21 is a view showing the logic format structure of a coded image recorded on an information recording medium according to the sixth embodiment of the present invention;

FIG. 22 is a block diagram showing an information processing apparatus according to the sixth embodiment;

FIG. 23 is a flow chart showing the operation of the information processing apparatus according to the sixth embodiment;

FIG. 24 is a view showing the display transition in the sixth embodiment;

FIG. 25 is a view showing the logic format structure of a coded image for inputting a password;

FIG. 26 is a view showing another logic format structure of the coded image recorded on the information recording medium according to the sixth embodiment;

FIG. 27 is a block diagram showing an information processing apparatus corresponding to the coded image of FIG. 26;

FIG. 28 is a flow chart showing the operation of the information processing apparatus corresponding to the coded image of FIG. 26;

FIG. 29 is a view showing the display transition on the information processing apparatus corresponding to the coded image of FIG. 26;

FIG. 30 is a view showing the logic format structure of a coded image recorded on an information recording medium according to the seventh embodiment of the present invention;

FIG. 31 is a block diagram showing an information processing apparatus according to the seventh embodiment;

FIG. 32 is a flow chart showing the operation of the information processing apparatus according to the seventh embodiment;

FIG. 33 is a view showing a dialog box displayed in the seventh embodiment;

FIG. 34 is a view showing the logic format structure of a coded image recorded on an information recording medium according to the eighth embodiment of the present invention;

FIG. 35 is a block diagram showing an information processing apparatus according to the eighth embodiment;

FIG. 36 is a flow chart showing the operation of the information processing apparatus according to the eighth embodiment; and

FIG. 37 is a view showing a dialog box displayed in the eighth embodiment.

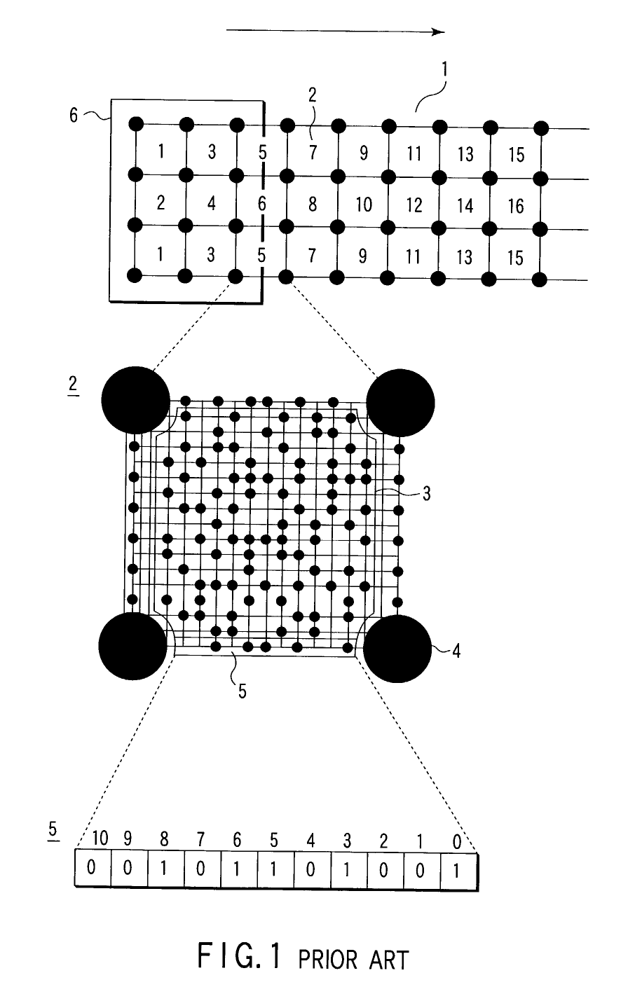

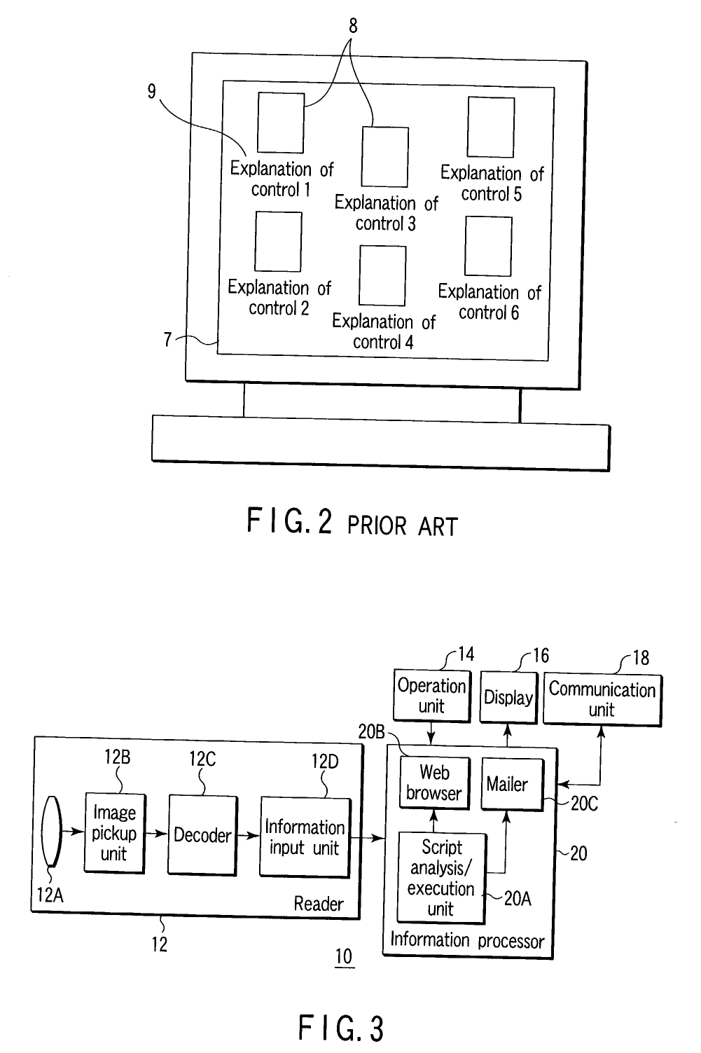

### DETAILED DESCRIPTION OF THE INVENTION

Preferred embodiments of the present invention will be described below with reference to the accompanying drawings.

[First Embodiment]

An information processing apparatus according to the first embodiment of the present invention will be described.

As shown in FIG. 3, a cellular telephone 10 with a Web browser function to which the information processing apparatus according to the first embodiment is applied is constituted by a reader 12, operation unit 14, display 16, communication unit 18, and information processor 20.

The reader 12 has a function of optically reading a coded image such as the above-described dot code 1. The reader 12 includes a lens 12A, an image pickup unit 12B for picking up a coded image via the lens 12A, a decoder 12C for reconstructing a file or data from the coded image picked up by the image pickup unit 12B, and an information input unit 12D for temporarily storing the file or data reconstructed by the decoder 12C and sending it to the information processor 20.

The operation unit 14 is a key input unit having a ten-key pad for dial and several function keys. The display 16 is a liquid crystal display. The communication unit 18 performs speech communication and exchange of information via a base station (not shown) by radio.

The information processor 20 executes information processing using a file or data input from the information input unit 12D, information input via the operation unit 14, and/or information obtained via the communication unit 18. The information processor 20 transmits information via the communication unit 18 and/or displays information on the display 16. More specifically, the information processor 20 includes a script analysis/execution unit 20A for analyzing and executing information contents from the information input unit 12D, operation unit 14 and communication unit 18, and a various application programs such as a Web browser 20B and a mailer 20C.

In this embodiment, the reader 12 is integrated with the cellular telephone 10. Alternatively, the cellular telephone 10 may include the operation unit 14, display 16, communication unit 18 and information processor 20, and the reader 12 may be connected as a separate device to the information processor 20 by wire or radio.

The information processing apparatus in this embodiment can also be applied to a PC, PDA, set-top BOX, net TV, and the like. In this case, the reader 12 is constituted as a separate device. In the set-top BOX or net TV, the reader 12 can be assembled into a remote controller.

An optically readable coded image (e.g., dot code 1) recorded on an information recording medium according to the first embodiment of the present invention will be explained.

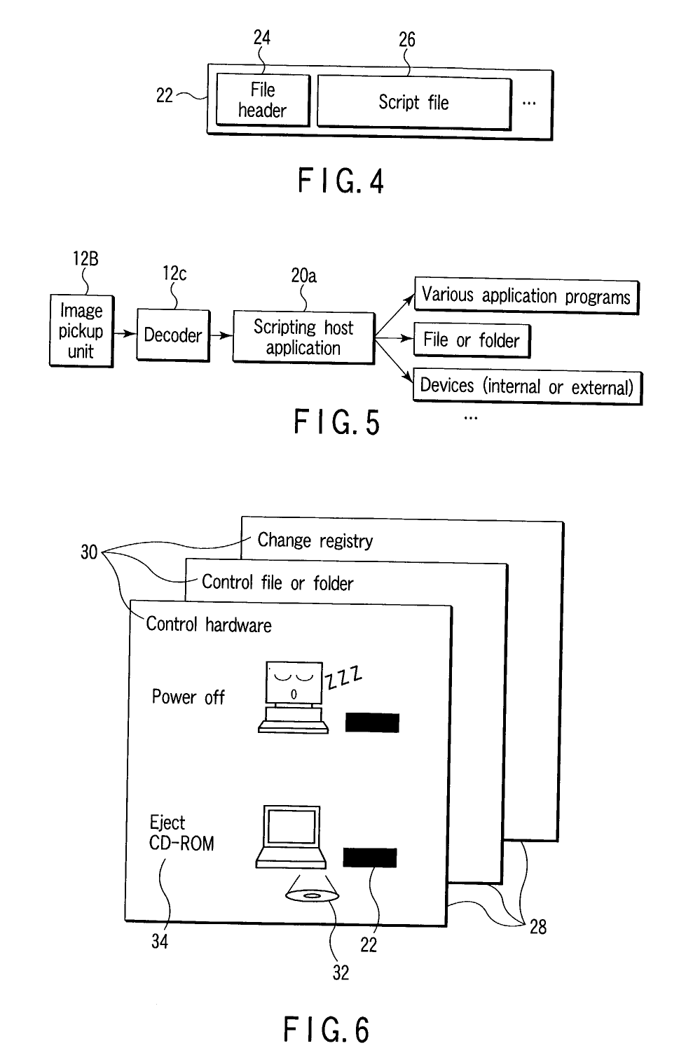

FIG. 4 is a view showing the logic format structure of a coded image 22. The coded image 22 contains a file header 24 and a script file 26.

The file header 24 contains various pieces of information such as the type of file contained in the coded image 22, compression/non-compression of the file, the compression scheme, and the file name. The script file 26 can be read, analyzed, and executed by a scripting host application. The script description contents include contents for processing or controlling various data files and folders, application programs, internal and external devices, and other objects.

As shown in FIG. 5, in the information processing apparatus according to the first embodiment, the image pickup unit 12B picks up the coded image 22, and the decoder 12C reconstructs the file header 24 and script file 26. A scripting host application 20a corresponding to the script analysis/execution unit 20A loads and executes the script file 26 to process or control various application programs such as the Web browser 20B or the mailer 20C, file or folder, internal or external device, and other objects.

FIG. 6 is a view showing an information recording medium 28 according to the first embodiment. On the information recording medium 28, the coded images 22 are printed. The coded images 22 are classified for respective control contents into genres which are easy to search and are convenient for the operator, and are edited every page. A heading 30 is attached to each page of each classified control genre. A symbolic illustration 32 representing each control content and an accurate explanation 34 of the control content by characters are printed near the corresponding coded image 22. The printout information recording mediums 22 are provided to a target operator.

Assuming Windows® 98, Windows Scripting Host (to be simply referred to as WSH hereinafter) is generally used as the scripting host application 20a. As the script file 26, a file with an extension “.vbs” described by VBScript or a file with an extension “.JS” described by JScript® is recorded.

Examples of contents for processing or controlling objects including application programs, files, and other devices by using the script file 26 are as follows:

To activate a setup dialog for an application program, file, or control panel

To stop power, to reboot the machine, to restart a window, to suspend, to log off, or the like

To empty the Trash, or to eject CD-ROM form an internal or externally connected CD-ROM drive

To set a default printer on the basis of a seal affixed to a printer manual

To create a URL or file shortcut on a desktop

To automatically register a URL in Favorites

Window operation: to close all windows, to align windows vertically or horizontally, to make windows overlap each other, or the like

To control access/write to text files, wordprocessor software documents, or spreadsheet software data files, or the like

To create, delete, or copy file or folder, or the like

To detect and display hardware information such as a hard disk capacity

In any case, according to the first embodiment, the contents of control or processing are classified for respective purposes, the classified contents are edited and printed as coded images together with simple illustrations and the descriptions of accurate control/processing contents to provide a publication. The publication is provided to any operator including a home user. The operator gets the publication, and can easily find out target control or processing by referring to illustrations. The operator can safely carry the control or processing into effect by confirming the descriptions of accurate control/processing contents. Further, the operator can easily execute the control or processing only by tracing the coded image.

[Second Embodiment]

The second embodiment of the present invention will be described.

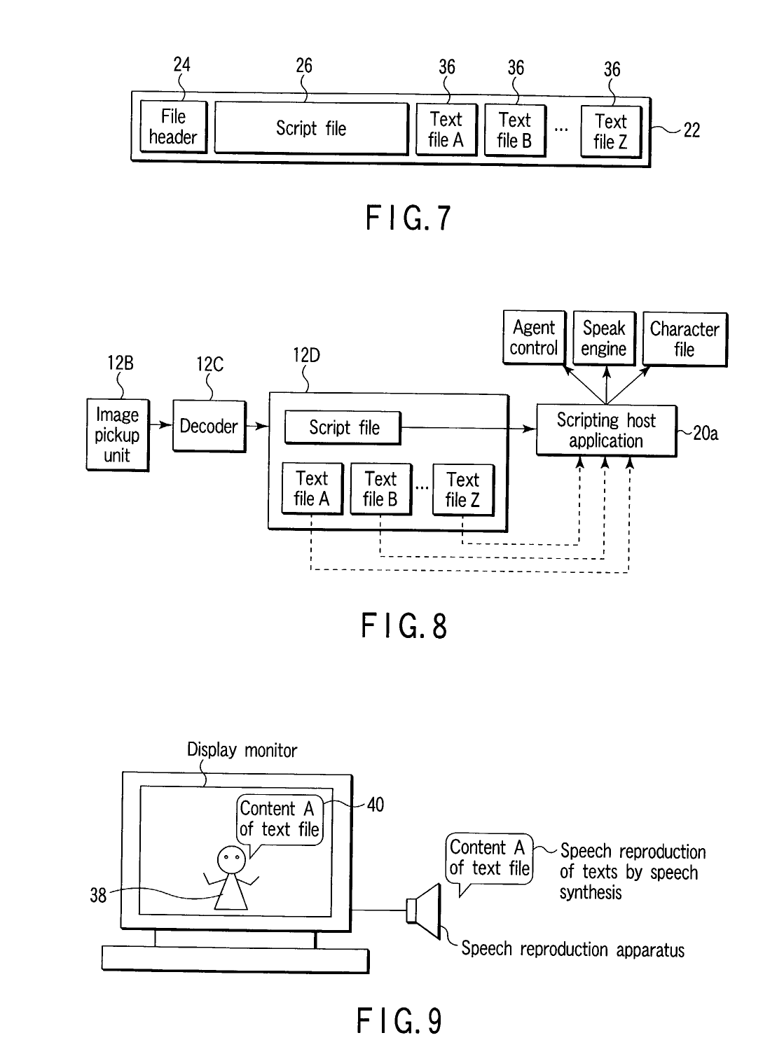

FIG. 7 is a view showing the logic format structure of a coded image 22 recorded on an information recording medium according to the second embodiment. The coded image 22 contains a file header 24, a script file 26, and a plurality of text files 36.

In this embodiment, the coded image 22 is the above-described dot code 1 which can record a large capacity of data.

As shown in FIG. 8, in an information processing apparatus according to the second embodiment, the coded image 22 is picked up by an image pickup unit 12B. The file header 24, script file 26, and text files 36 are reconstructed by a decoder 12C, and temporarily stored in an information input unit 12D. Then, a scripting host application 20a corresponding to a script analysis/execution unit 20A loads and executes the script file 26 to control three objects, i.e., Agent control, speak engine, and character file functioning as three application programs.

The second embodiment also assumes Windows® 98. WSH installed as standard equipment in Windows® 98 or later is used as the scripting host application 20a. In addition, MS-Agent is utilized as an agent function which can be controlled by a script capable of controlling WSH.

MS-Agent is a Microsoft technique installed as standard equipment in Windows® 98 or later. While a prepared agent character 38 moves in accordance with a script, the contents of a text file or the contents of a text described in the script are displayed as a balloon 40 in accordance with the script description, as shown in FIG. 9. Alternatively, the contents of a text displayed in the balloon 40 are read aloud by speech synthesis in synchronism with the display of the balloon 40.

This agent function is realized by controlling the three application programs, i.e., Agent control (MS-Agent.exe), speak engine (TV_enua.exe), and character file (Genie.exe or the like) by the WSH which refers to the script contents.

Hence, a script file such as VBScript described to control the agent character 38 is printed as a coded image on a paper medium such as a guidebook, advertisement leaflet, or product catalogue serving as the information recording medium according to the second embodiment. The operator can receive an easy-to-understand guidance, advertisement, or explanation by the motion of the agent character 38 and text-to-speech synthesis in a programmable manner in accordance with the contents of the printed matter.

For example, a VBScript file (file with an extension “.vbs”) as the script file, and additional information about the article contents of a magazine are recorded as a plurality of displayable text files A, B, . . . , Z on a coded image 22 printed on the magazine. The VBScript file is loaded into WSH to control the applications (Agent control, speak engine, and character file). The operation of the agent character 38 on the screen, balloon display of the contents of the text file 36, and reading of the contents of the text file 36 by text-to-speech synthesis are synchronized. Meanwhile, the text files A, B, . . . , Z are read aloud in a programmable manner. The contents of the text files A, B, . . . , Z are expressed in a programmable manner together with the motion of the agent character 38, display of the balloon 40, and speech synthesis. Note that the “programmable manner” means various condition branches and decisions in executing the script program. For example, the text files A, B, . . . are messages used at respective time points. The time point when the script is executed is referred to and determined. A corresponding text file 36 is loaded from the text files A, B, . . . , thereby expressing the message corresponding to the time point.

In the second embodiment, text data exists as the text file 36. If, however, text data is directly described in the script file 26, the text file 36 can be omitted. Information which controls the agent character 38 is recorded in the script file 26 and directly activates WSH. In some cases, control information for the agent character 38 is described in an HTML script, XML (Extensible Markup Language), or XSL (Extensible Stylesheet Language) script, and the script file 26 activates Internet Explorer serving as a Web browser which loads the HTML script, XML script, or XSL script. In general, MS-Agent runs not on Netscape® Navigator but on Internet Explorer. The script file 26 controls to activate Internet Explorer. This control can be omitted if plug-in software for Netscape® Navigator is provided and installed.

As described above, the second embodiment utilizes the feature of the dot code 1 capable of recording a large capacity of data in an extensible way. In addition to the script file 26 and binary data such as another script file, the text file 36, image/speech/sound data or a Java class file can be recorded on a coded image. In reconstruction, the recorded data are used together with the script. The another script file, the text file 36, the another binary data or the like can be displayed and used in a programmable manner. The contents can be utilized only on the sheet surface without the mediacy of any network. The operator can immediately enjoy the contents without any communication cost. The value-added publication or paper medium can be further improved.

[Third Embodiment]

The third embodiment of the present invention will be described.

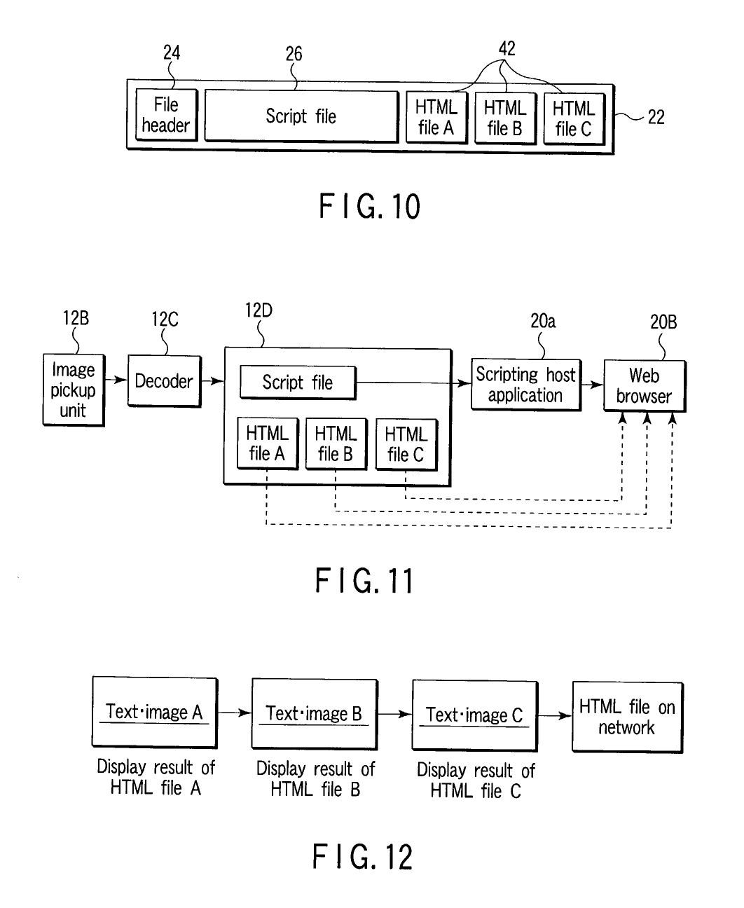

FIG. 10 is a view showing the logic format structure of a coded image 22 recorded on an information recording medium according to the third embodiment. The coded image 22 contains a file header 24, a script file 26, and a plurality of HTML files 42.

In this embodiment, the coded image 22 is the above-described dot code 1 which can record a larger capacity of data than a barcode or the like.

As shown in FIG. 11, in an information processing apparatus according to the third embodiment, the coded image 22 is picked up by an image pickup unit 12B. The file header 24, script file 26, and HTML files 42 are reconstructed by a decoder 12C, and temporarily stored in an information input unit 12D. Then, a scripting host application 20a corresponding to a script analysis/execution unit 20A loads and executes the script file 26. The HTML files 42 as objects are browsed by a Web browser 20B serving as another object.

The third embodiment assumes that the scripting host application 20a is an active scripting host such as WSH or Tcl/Tk which can run not only on Windows® but also on Mac OS™, LINUX®, or UNIX®, and that Web browser software can be used.

The plurality of HTML files 42 are recorded on the coded image 22. When the HTML file 42 is displayed on Web browser software, texts and images displayed within the page are hypertext-linked to another HTML file, as shown in FIG. 12. The script file 26 to be loaded, analyzed, and executed by the scripting host application 20a is recorded on the coded image 22. The script file 26 is so described as to be activated in a designated state (window display position, display size, text size, and the like) on the Web browser 20B on which an HTML file A is designated among the plurality of HTML files 42.

When the coded image 22 is optically read, the script file 26 is loaded into the scripting host application 20a. Web browser software described in the script file 26 is activated in a designated state.

For example, an information provider who creates and provides an information recording medium according to the third embodiment may want to limit browser software used by the operator to a specific one depending on the contents of the HTML file 42. That is, Web browser software of company A and Web browser software of company B are different in corresponding HTML commands and usable functions, which further change depending on the version. Web browser software desired by the information provider may also change depending on contents.

In many cases, the operator wants to change the window display position or minimize the window display size from the relationship with another application in use or another displayed Web content. Also, control of increasing the text size is effective for, e.g., an elder operator in consideration of the convenience of a target operator for each publication.

In accordance with the description of the script file 26, the HTML file A is loaded into the Web browser software controlled in accordance with this description. The HTML file A has a hypertext relationship with HTML files B and C. These files are associated with each other and constitute a hierarchical structure. The coded image 22 can be summed up for each theme or purpose. This provides easy browsing and utilization, and increases choices of the layout design of the coded image 22.

Note that an information processing method of transferring only the HTML file A to Web browser software without recording the script file 26 on the coded image 22 may be adopted. The HTML files 42 need not be limited to the three HTML files A, B, and C. Each HTML file 42 may be hypertext-linked to an external HTML file not recorded on the coded image 22. Instead of the HTML file 42, an XML, XSL, or XHTML file may be employed, or a CHTML, HDML, or WML file used in a cellular telephone may be used. A GIF image or JPEG image, sound information such as a Java applet or MIDI file, and audio information such as a WAVE file which are read out from such HTML files may be recorded on the coded image 22.

Two examples of the detailed recording contents and utilization method of the third embodiment, and their merits will be described.

1) Pieces of manual or dictionary information are associated with each other and recorded on a coded image. This provides supplemental remarks which exploit the merits of the hypertext without occupying space.

2) As a means for accessing the homepage of each shop on the Web via a coded image printed on the shop guide page of a guidebook for restaurants or shops, the URL of one shop is recorded in the coded image, and this coded image is read by a cellular telephone with a coded-image reading function to easily access the target homepage.

This coded image may contain not only the URL of one shop but an HDML or CHTML file including the URLs of a plurality of shops such as chain stores. In this case, the space on the sheet surface can be saved in comparison with separately encoding and printing the URLs of shops.

A plurality of HDML or CHTML files hierarchized and linked to each other by using a hypertext or the like may be recorded in a coded image. A target shop can be easily searched for by a cellular telephone having the coded-image reading function.

If a script which allows making a call by cursor designation on the display is described in the HDML or CHTML file, the operator can easily make a call after the search. For example, after reading the code, the operator of the cellular telephone sequentially selects area search→prefecture→city→shop (country→state→city→shop) on the display with the cursor or the like. The operator can find out a target shop and directly call the shop.

This merit can be provided offline from the sheet surface of a guidebook or the like without network connection.

With a structure which enables directly registering information obtained by reading the coded image in a database prepared inside the cellular telephone, the operator can always receive the above-mentioned merit without the guidebook if only to read the coded image and register information. Also, the shop can keep the operator as a regular customer.

[Fourth Embodiment]

The fourth embodiment of the present invention will be described.

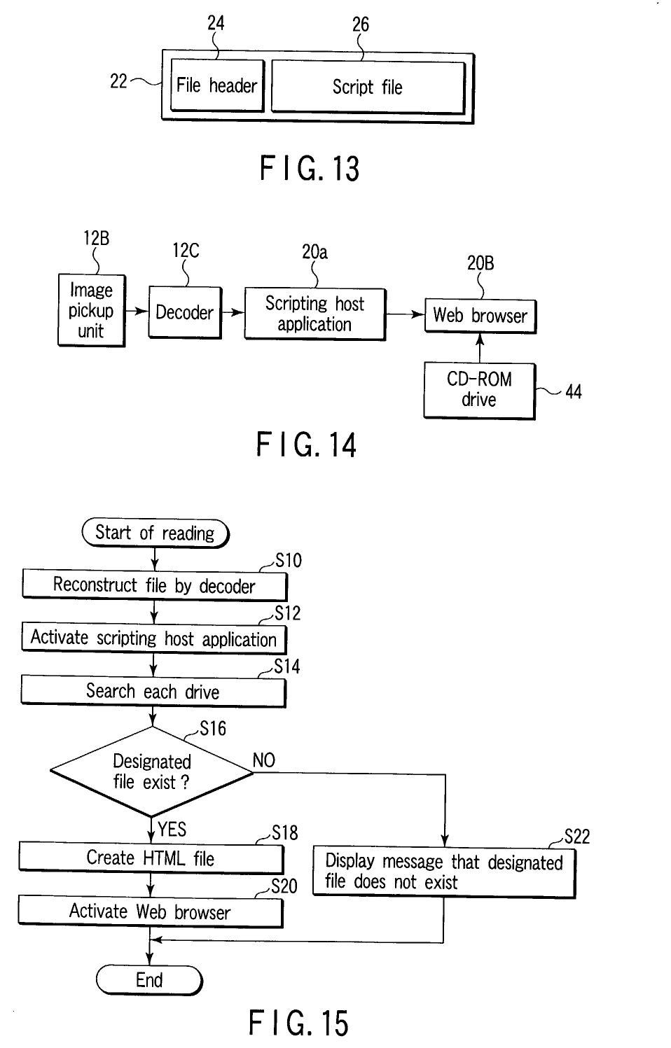

FIG. 13 is a view showing the logic format structure of a coded image 22 recorded on an information recording medium according to the fourth embodiment. The coded image 22 contains a file header 24 and a script file 26.

The fourth embodiment also assumes that a scripting host application 20a is an active scripting host such as WSH or Tcl/Tk which can run not only on Windows® but also on Mac OS™, LINUX®, or UNIX®, and that Web browser software can be used. The script file 26 which can be loaded into the scripting host application 20a and can be activated is recorded on the coded image 22.

In the information processing apparatus according to the fourth embodiment, as shown in FIGS. 14 and 15, a decoder 12C reconstructs the script file 26 after the start of reading the coded image 22 (step S10). The reconstructed script file 26 is activated by the scripting host application 20a, e.g., an active scripting host such as WSH and the contents of the script file are analyzed and executed (step S12). The description contents of the script file 26 are as follows.

Whether a file on a CD-ROM as a designated object exists on each drive is searched for (step S14). That is, which of drives “D:” or “E:” is a CD-ROM drive 44 changes depending on the environment of the operator. Further, it is unknown whether a target CD-ROM is set in the CD-ROM drive 44 and a target file exists. Thus, a target file must be searched for.

If the target file exists as a result of search (YES in step S16), an HTML file is created in accordance with the contents described in the script file 26, and a description for reading out the file on the CD-ROM is added to the HTML file to complete the HTML file (step S18). The HTML file is opened on a designated Web browser application (step S20). The file is read out from the CD-ROM drive 44 in accordance with the description of the HTML file, and designated display is performed.

If the file is determined not to exist as a result of search (NO in step S16), a message that the designated file does not exist is displayed (step S22).

In the fourth embodiment, predetermined information representing whether a target file exists is acquired from a CD-ROM serving as an object, and then processing is done.

Detailed file contents of the fourth embodiment, an information recording medium which records the contents, a utilization method, and the merits will be described.

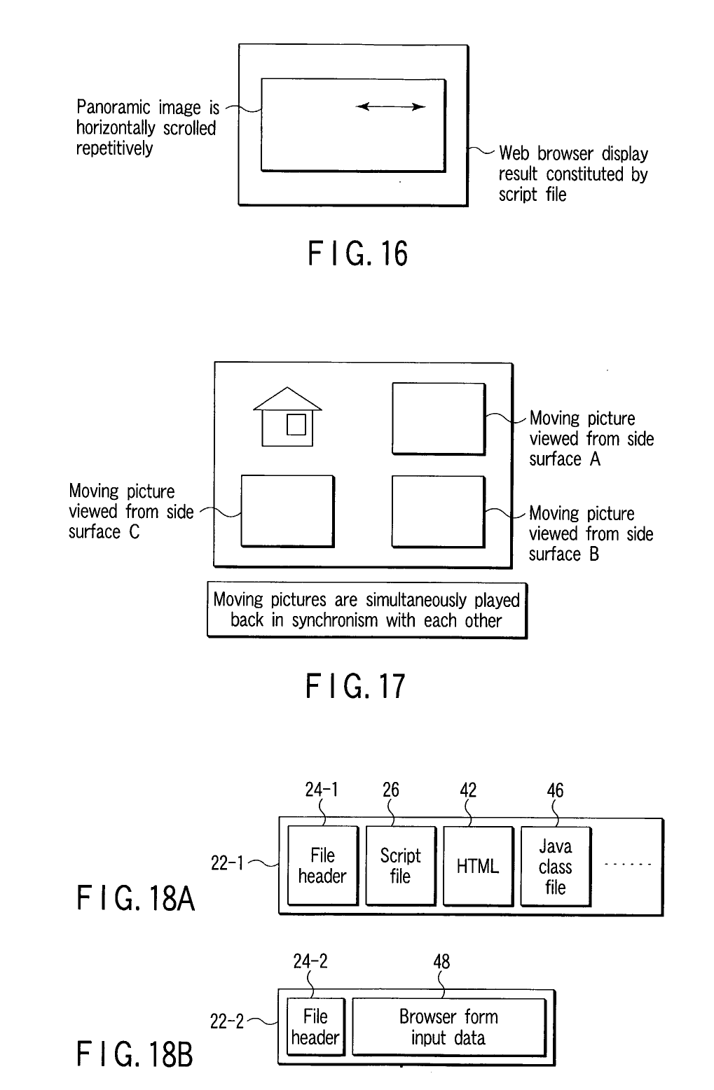

1) A coded image at a given point is loaded. Then, a designated landscape image is read out from a CD-ROM. As shown in FIG. 16, the image is horizontally scrolled on the Web browser. This image can be used for a map which reproduces the 360° circumference of the place, a travel/hotel/shop/restaurant guide, or an information magazine for renting or real estate. In this case, a panoramic image viewed from that place can be directly reproduced from the point on the map or the guidebook article.

2) A plurality of moving picture files are read out from a CD-ROM, and the moving pictures are simultaneously played back at corresponding positions on the screen. Merits for respective applications are as follows:

\mathring{1} Catalogue and sales promotion goods: Sales are promoted using three-sides moving pictures of a car, vehicle, pet, building, and the like. As for the building, changes with seasons and the time can be simultaneously confirmed from three side-views A, B and C by compressing the time interval, as shown in FIG. 17.

\mathring{2} Teaching material and manual: The moving pictures of a given object are played back from various angles in temporary synchronism with each other, which helps understanding.

\mathring{3} Textbook for Japanese dance or another dance: Dance images are played back from various angles in synchronism with each other, and the temporal relationship and three-dimensional form are grasped. The words of a song or an explanation is scrolled, which helps understanding together with a text.

In the fourth embodiment, an HTML file is created from the script file 26 recorded on the coded image 22, and the Web browser 20B is activated. The above object may be achieved by recording an HTML file on the coded image 22 and describing JavaScript or VBScript in the HTML file. Alternatively, only a simple HTML file may be recorded on the coded image 22 if the drive name of the CD-ROM drive 44 is determined in advance.

When the script file 26 is recorded on the coded image 22 to create an HTML file, and the Web browser 20B is activated, the activation method of the Web browser 20B can be designated in detail from the script file 26.

[Fifth Embodiment]

The fifth embodiment of the present invention will be described.

The fifth embodiment also assumes that a scripting host application 20a is an active scripting host such as WSH assuming Windows® or Tcl/Tk which can run on Mac OS™, LINUX®, or UNIX®, and that Web browser software serving as an object can be used.

The fifth embodiment uses first and second coded images. As shown in FIG. 18A, the first coded image 22-1 contains a file header 24-1, a script file 26 which can be loaded into a scripting host application 20a and can be activated, an HTML file 42 serving as an object input to a Web browser 20B activated by the script file 26, a Java class file 46 serving as an object read out from the HTML file 42, and an image file, text file, and the like serving as objects which are referred to from the HTML file or Java class file. As shown in FIG. 18B, the second coded image 22-2 contains a file header 24-2 and browser form input data 48.

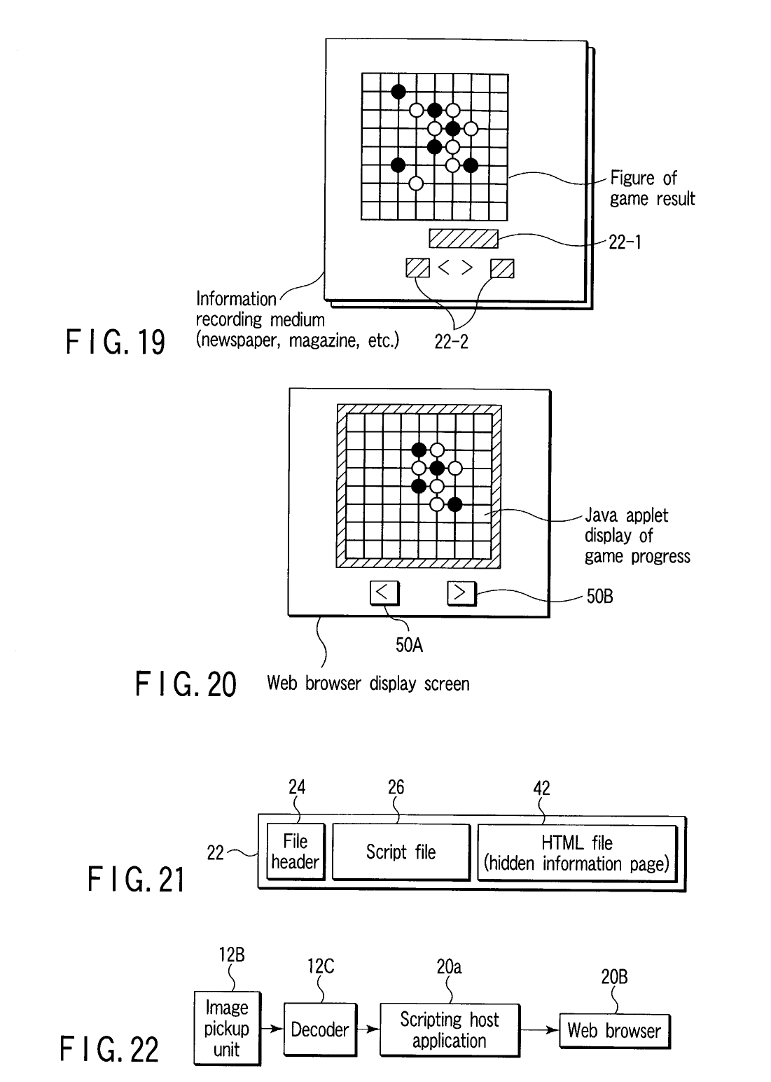

In the fifth embodiment, as shown in FIG. 19, the first and second coded images 22-1 and 22-2 are recorded on an information recording medium such as a newspaper or magazine. After the start of reading the first coded image 22-1, a decoder 12C reconstructs the script file 26. The reconstructed script file 26 is activated by a scripting host application, e.g., an active scripting host such as WSH. The contents of the script file 26 are analyzed and executed. In this case, the description contents of the script file 26 are to activate Web browser software by the HTML file 42 recorded on the first coded image 22-1. In activating the Web browser 20B, the type of Web browser 20B may be designated, or an activation method such as the browser window position or size may be designated. If the activated HTML file 42 contains such a description as to designate, load, and display the Java class file 46 recorded on the first coded image 22-1, the class file containing the program as described above is loaded.

In the fifth embodiment, the class file is a program which reproduces a “go” game, as shown in FIG. 20. Immediately after the operator reads the first coded image 22-1, the Web browser 20B is activated to allow using a Java applet which reproduces the “go” game.

The display contents of the Java applet change depending on a data input to the Web browser form. For example, in this case, a browser form < button 50A and browser form > button 50B are displayed. The buttons 50A or 50B are turned on to display the game result of the Java applet forward or backward.

The browser form input data 48 is recorded on the second coded image 22-2. If the second coded image 22-2 is reconstructed during display of an object displayed as a result of reconstructing the first coded image 22-1, an information processor 20 can input data to a corresponding browser form by referring to the browser form input data 48 recorded on the second coded image 22-2.

For example, in this case, < and > button inputs are prepared as the browser form input data 48. Only by reading the second coded image 22-2, the same effects as turning on the browser form < button 50A or browser form > button 50B can be obtained. The game progress can be fed forward or backward. When the information processing apparatus according to the fifth embodiment is a PC, only a coded image can be scanned while the operator need not exchange a coded-image reader for reading the first coded image 22-1 with a mouse for click. As a result, user I/Fs can be integrated.

The designated Web browser 20B is immediately activated only by manually scanning the first coded image 22-1. The Web browser 20B loads a Java applet, allowing quickly using a desired application. The game result can be fed forward or backward only by scanning the second coded image 22-2, e.g., coded images < or > on an information recording medium such as a magazine or newspaper. For a PC system, the operator need not hold a mouse, and user I/Fs can be integrated. For a cellular telephone 10 which incorporates a reader 12 but does not have any mouse, the forward/backward result can be displayed on the screen of the display 16 only by tracing a coded image on the cellular telephone main body.

Detailed file contents of a coded image in the fifth embodiment, an information recording medium which records the contents, and a utilization method will be described.

1) A java program for simulating physics, mathematics, astronomy, economics, or another phenomenon is recorded near an explanatory figure on a teaching material, magazine, or the like. The target phenomenon is reproduced, and the parameters are changed only on the coded image 22-2, in which the browser form input data 48 is recorded, to display the result.

2) A java program is recorded on a fortune-telling magazine. This program allows inputting parameters such as Feng Sui, constellation, blood type, and biorhythm only on the coded image 22-2, in which the browser form input data 48 (text box, radio button, combo box, or the like) is recorded, displaying the fortune-telling result.

3) A script program for searching a CD-ROM or network for a moving picture or program and downloading the searched result is recorded on a coded image. In this case, the coded image 22-2 on which the browser form input data 48 is recorded for the answer entry of each question is printed. The operator answers each question by scanning the coded image by means of a cellular telephone 10 which incorporates a reader 12. Then, the answer results for respective answer entries are sequentially input to the script program. The final search result is downloaded as a moving image or program from the CD-ROM or network. The downloaded result is displayed, reproduced, and executed.

[Sixth Embodiment]

The sixth embodiment of the present invention will be described.

The sixth embodiment also assumes that a scripting host application 20a is WSH or another scripting host such as Tcl/Tk on the assumption of an OS other than Windows® as far as the environment has a Web browser.

As shown in FIG. 21, a coded image 22 contains a file header 24, a script file 26 which is loaded into the scripting host application 20a, analyzed, and executed, and an HTML file 42 serving as an object which is loaded into a Web browser 20B and displayed. The HTML file 42 is a hidden information page.

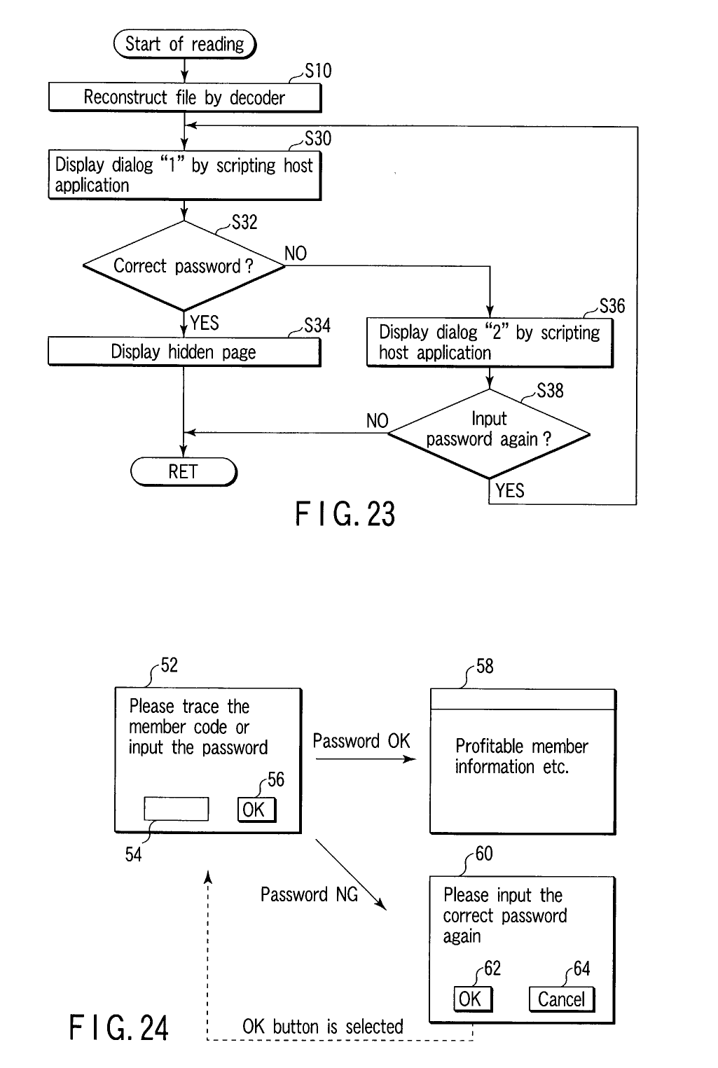

In an information processing apparatus according to the sixth embodiment, as shown in FIGS. 22 and 23, a decoder 12C reconstructs the script file 26 after the start of reading the coded image 22 (step S10).

The script file 26 is described such that after being loaded into the scripting host application 20a, a dialog “1” 52 serving as a first dialog box as shown in FIG. 24 is displayed. The scripting host application 20a executes the contents of the reconstructed script file 26 to display the dialog “1” 52 (step S30).

The dialog “1” 52 has a password input box 54. The script file 26 is described such that if the operator manually inputs a password, a password check routine at the timing at which the operator clicks an OK button 56 is started, and whether the input password is correct or incorrect is checked. If the input password is determined to be correct (YES in step S32), designated Web browser software is activated to load the HTML file 42 on which the hidden information page is described. As a result, a hidden information page 58 is displayed (step S34).

If the input password is determined to be incorrect (NO in step S32), the scripting host application 20a displays a dialog “2” 60 serving as a second dialog box in accordance with the description of the script file 26 (step S36). The script file 26 is further described such that if the operator clicks an OK button 62, i.e., if the operator is to input a password again (YES in step S38), the dialog “1” 52 is displayed again; if the operator clicks a cancel button 64 (NO in step S38), the processing ends.

In the sixth embodiment, a hidden information page is stored in the coded image 22 printed on the sheet surface of an information recording medium. This hidden information page can be acquired by inputting a correct password. This is suitable for members-only information services using printing media. As an example of such services, the coded image 22 is printed on an information recording medium such as a generally printed/published/distributed newspaper, magazine, or leaflet, and a password is given to only a member. As hidden information, detailed information or the latest information concerning a generally distributed printed matter, a special price or hidden information, prospect information by a famous expert, or the like is recorded on the coded image 22. This information can be provided to only a member who pays membership fees.

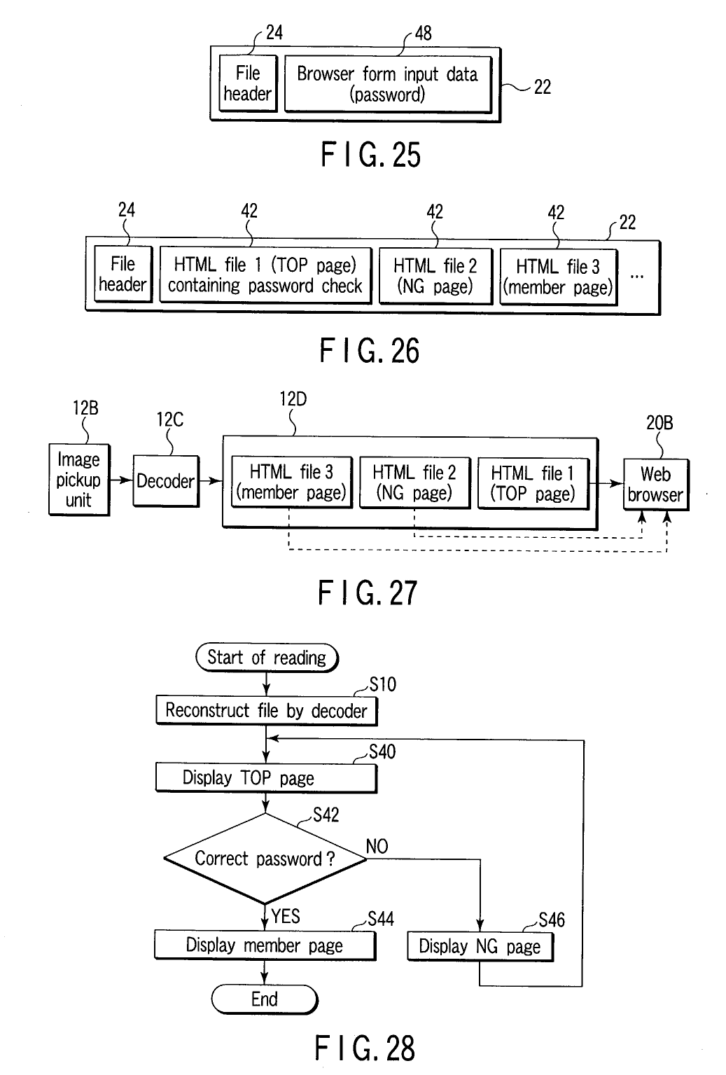

In the sixth embodiment, a password is manually input. Alternatively, information such as a password can be encoded into an image. That is, as described in the fifth embodiment, a password is recorded on the browser form input data 48, as shown in FIG. 25. The coded image 22 containing the browser form input data 48 is recorded on a membership card (not shown) serving as an information recording medium. This membership card is distributed to a member. The member can input the password only by reading the coded image 22.

The hidden information page is recorded on the HTML file 42 stored in the coded image 22. Instead of recording hidden information on the HTML file 42, the hidden information may be set on a network, and only link information may be described in the HTML file 42. Alternatively, hidden information may be set on both the HTML file 42 and a linked network. In this case, the values of information such as significance, concealment, information amount, real-time distribution, and discount may be differed, and a password input means may be provided for each information. As this password input means, different passwords may be set for respective pieces of hidden information, or one password may be used to determine disclosure of pieces of hidden information.

The sixth embodiment employs a script file assuming the scripting host application 20a. Alternatively, as shown in FIG. 26, three HTML files 42 may be recorded as the coded image 22. More specifically, in an HTML file “1”, a TOP page having a function of checking an input password is described by describing a Java script. In an HTML file “2”, an NG page displayed when a password is incorrect is described. In an HTML file “3”, a member page including hidden information is described. Further, as shown in FIGS. 27 and 28, the decoder 12C may reconstruct the three HTML files 42 after the start of reading the coded image 22 (step S10). These HTML files 42 may be temporarily saved by the information input unit 12D. An HTML file 42 which designates an information processing method according to the sixth embodiment may be transferred to the Web browser 20B to activate the Web browser 20B. In this case, the HTML file “1” in which the TOP page is described is transferred to the Web browser 20B.

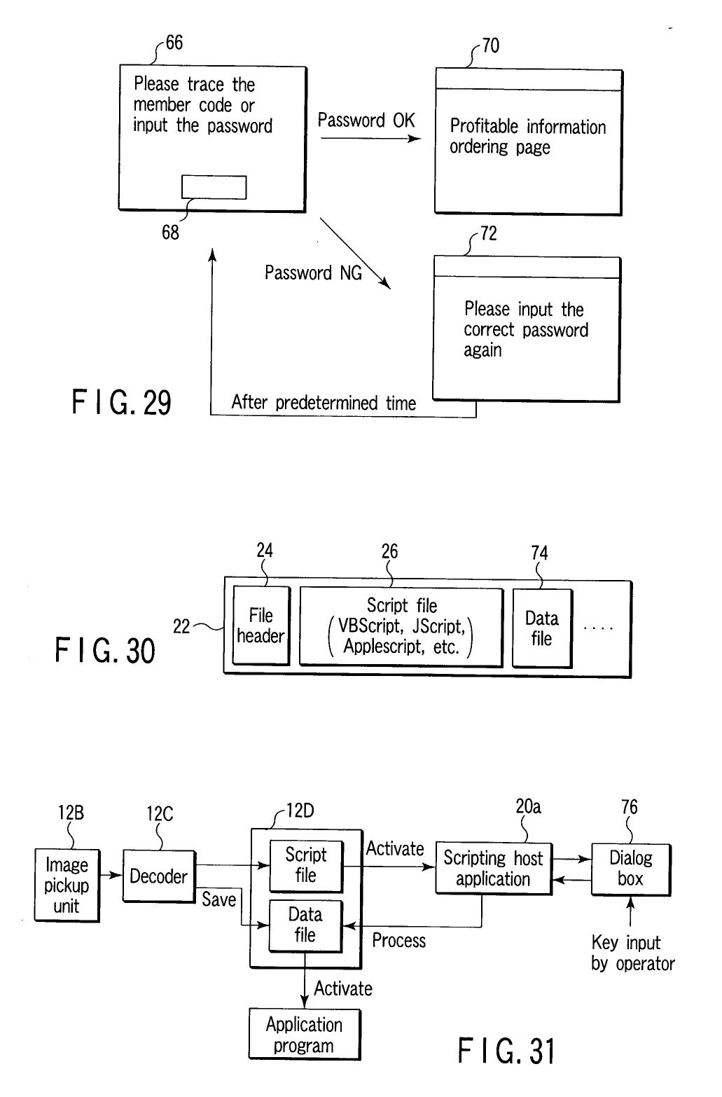

Subsequent processing depends on the Web browser 20B and the described contents of the HTML file 42. First, as shown in FIG. 29, a TOP page 66 having a password input box 68 is displayed (step S40). A password may be input to the password input box 68 via an operation unit (keyboard) 14, as described above. Alternatively, a password may be input by reading the coded image 22 containing the browser form input data 48 as shown in FIG. 25.

If the input password is correct (YES in step S42), a member page 70 described in the HTML file “3” is displayed (step S44). If the input password is incorrect (NO in step S42), an NG page 72 described in the HTML file “2” is displayed (step S46). In this case, an HTML script which returns the display to the TOP page 66 upon the lapse of a predetermined time is preferably described in the HTML file “2”.

[Seventh Embodiment]

The seventh embodiment of the present invention will be described.

FIG. 30 is a view showing the logic format structure of a coded image 22 recorded on an information recording medium according to the seventh embodiment. The coded image 22 contains a file header 24, a script file 26, and a data file 74.

The data file 74 is an object such as a binary file used by a text file or each application program. The script file 26 can be loaded into a scripting host application 20a, and can be activated to add, delete, or edit the contents of the data file 74.

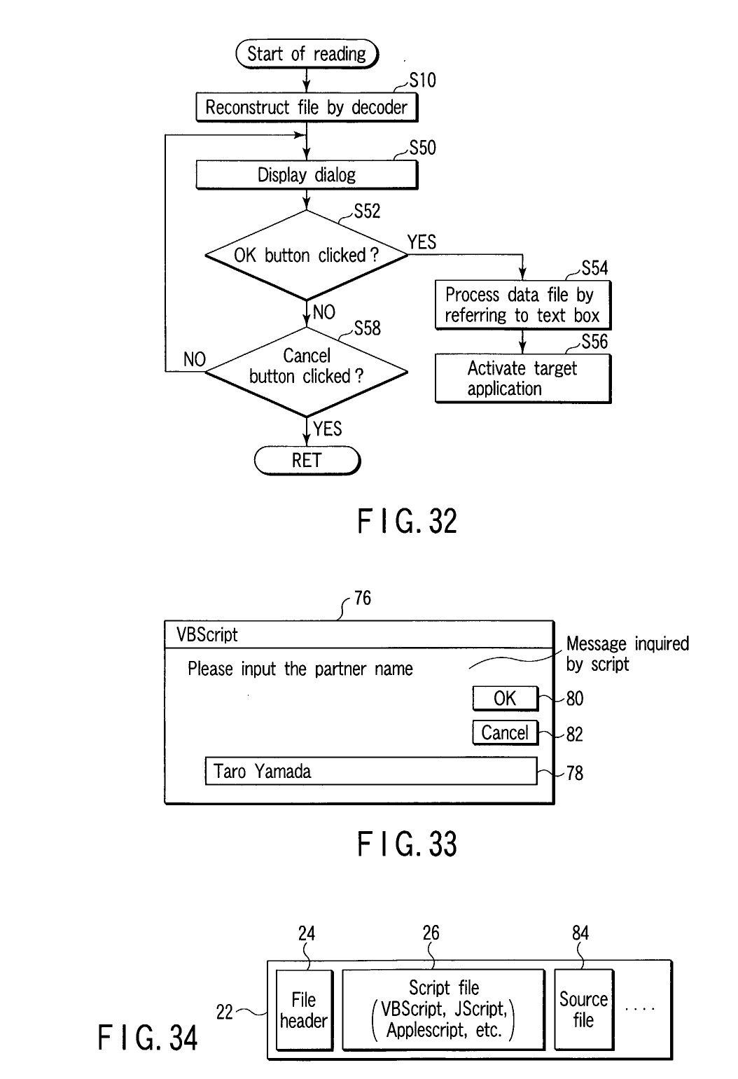

As shown in FIGS. 31 and 32, in an information processing apparatus according to the seventh embodiment, the coded image 22 is sensed by an image pickup unit 12B. The script file 26 and data file 74 are reconstructed by a decoder 12C, and temporarily stored in an information input unit 12D (step S10). Then, a scripting host application 20a corresponding to a script analysis/execution unit 20A loads, analyzes, and executes the script file 26, and a dialog box 76 as shown in FIG. 33 is displayed (step S50).

The dialog box 76 has an operator answer text box 78. The script file 26 is described as follows: if the operator manually inputs an answer to an inquiry, the data file 74 saved in the information input unit 12D is processed at a timing when the operator clicks an OK button 80 (YES in step S52) in accordance with the answer input to the answer text box 78 (step S54). A target application program serving as an object described in the script file in advance is activated to load the data file 74 (step S56). If a cancel button 82 of the dialog box 76 is clicked (YES in step S58), the processing ends.

After the data file 74 is processed in accordance with the click of the OK button 80, another dialog box may be displayed to make another inquiry.

Detailed file contents of a coded image in the seventh embodiment, an information recording medium which records the contents, and a utilization method will be described.

1) Automatic homepage building templates: A dialog box displayed in accordance with the script file 26, e.g., a VBScript description inquires profiles such as the birthday, name, and address of the operator. The operator answers the inquiries, finally building a self-introduction homepage.

2) Wordprocessor templates: A dialog box displayed in accordance with a VBScript description inquires necessary items of the operator. The operator answers the inquiries to complete a fixed-form wordprocessor document.

3) New Year's card templates: Fixed forms for letters or New Year's cards are printed on pages. A script which allows completing contents by answering a message box is encoded into an image for each page. The operator easily searches a book for a fixed form with a target or favorite document or design (the operator can directly find out a favorite one because of a book). The operator answers the inquiries to complete a greeting document or New Year's card file.

4) Application preparation tool: A fixed form to be applied to a public agency or service counter is completed on wordprocessor software via inquiries to the operator.

5) Quote preparation tool: A script is encoded into an image which controls spreadsheet software via an answer to a message box so as to provide the calculation results of monthly payments and payments in bonus months for each payment pattern on, e.g., the loan repayment page of a life insurance brochure or a catalogue for various goods.

6) Presentation material preparation tool: Presentation software is controlled via input of necessary items such as the company name, product name, and product concept in accordance with inquiries on a message box that cause the operator to answer questions. The necessary items are filled to complete fixed-form presentation materials.

In this case, the application program to be activated may be a scripting host application, and the data file may be the source script file of the scripting host application.

[Eighth Embodiment]

The eighth embodiment of the present invention will be described.

In the eighth embodiment, a coded image 22 as shown in FIG. 34 which contains a program source file 84 serving as an object, and a script file 26 for editing the contents of the source file 84 by answering questions on a message dialog box and for determining the compile method of the edited source file 84 is printed on a program menu book serving as an information recording medium. Even a PC beginner can create an original execution program by answering simple questions.

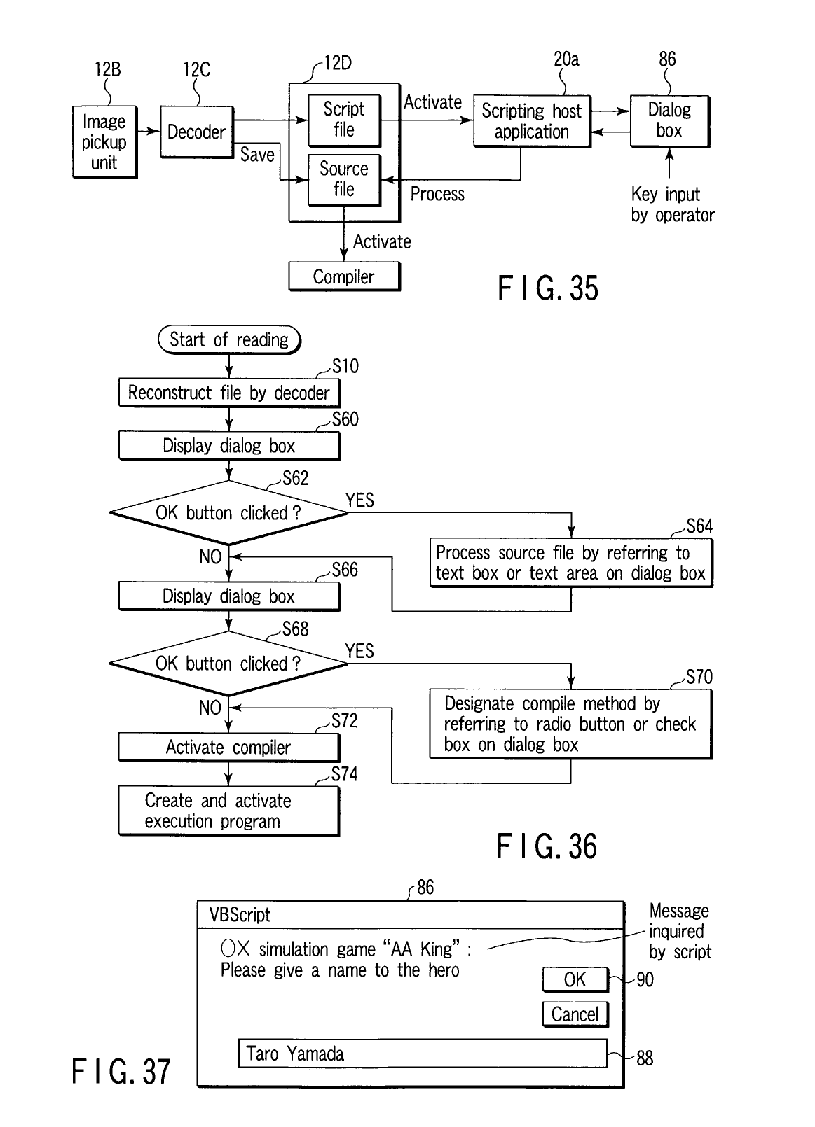

More specifically, as shown in FIGS. 35 and 36, in an information processing apparatus according to the eighth embodiment, a desired program source file is selected from the program menu book. A corresponding coded image 22 is picked up by an image pickup unit 12B. The script file 26 and source file 84 are reconstructed by a decoder 12C, and temporarily stored in an information input unit 12D (step S10). Then, a scripting host application 20a loads and executes the script file 26. A dialog box 86 as shown in FIG. 37 is displayed (step S60).

The dialog box 86 has an operator answer text box 88. The script file 26 is described as follows: if the operator manually inputs an answer to an inquiry, the source file 84 saved in the information input unit 12D is edited and processed at a timing when the operator clicks an OK button 90 (YES in step S62) in accordance with the answer input to the answer text box 88 (step S64).

As for a method of compiling the edited program source file after the contents of the source file 84 are edited, the script file 26 is described as follows: a dialog box (not shown) is similarly displayed (step S66). If the operator inputs an answer to an inquiry and clicks an OK button (step S68), a compiling method is designated in accordance with the answer (step S70). A compiler is activated (step S72), and the edited program source file is compiled to create and activate an execution program (step S74).

As a desired example by the operator in creation of an execution program, a resource such as an image or speech is contained in an execution program so as not to be externally extracted, or is moved to the outside so as to enable the user to exchange the resource.

The compiler for compiling a program source file is, e.g., hsped2.exe serving as both the editor and compiler of Hot Soup Processor®. The program source file is, e.g., a file with an extension “.AS” which can be edited and compiled by hsped2.exe.

The present invention has been described based on the above embodiments. The present invention is not limited to the above embodiments, and can be variously changed and modified within the spirit and scope of the present invention.

For example, the above embodiments have exemplified a dot code as an optically readable coded image. As the form of the coded image, various coded images can be employed in addition to the dot code.

In the seventh and eighth embodiments, the script file 26 and source file 84 may be set on a server where they can be acquired via a network including the Internet or in a hard disk, CD-ROM, or another accessible memory. Only address information of the script file 26 and source file 84 on the server or memory may be recorded on the coded image 22. Then, the same processing as that described in the seventh or eighth embodiment may be performed. As the address information, a URL or URI (Uniform Resource Identifier) may be recorded. Alternatively, a numerical value corresponding to the URL or URI may be recorded. The same processing as that described in the seventh or eighth embodiment may be done by referring to a table representing the correspondence between the URL or URI and the numerical value set on the network or in the memory such as a CD-ROM or hard disk.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information recording medium comprising:
a portion where a visually recognizable image directly read by a human eye is recorded; and
a portion where digital information is recorded as an optically readable coded image obtained by encoding the digital information,
wherein the digital information contains a script to designate an object associated with an information processing apparatus which processes digital information obtained by optically reading and decoding the coded image and to perform at least one of processing and control.

2. A medium according to claim 1, wherein the digital information contains the script in a file form.

3. A medium according to claim 1, wherein the object includes a data file.

4. A medium according to claim 1, wherein the object includes a program.

5. A medium according to claim 1, wherein the object includes at least one of an internal device of the information processing apparatus and an external device connected to the information processing apparatus.

6. A medium according to claim 1, wherein the digital information further contains data used for the at least one of processing and control.

7. A medium according to claim 1, wherein the script is so described as to acquire predetermined information from the object in order to perform the at least one of processing and control for the designated object.

8. A medium according to claim 1, wherein the visually recognizable image includes at least one of a symbolic illustration representing a content and an explanation using texts of the content for each content of the at least one of processing and control.

9. A medium according to claim 1, wherein the coded image can be manually read.

10. A medium according to claim 9, wherein
the coded image is formed by arraying a plurality of blocks, and
each block includes:
a data dot pattern on which dots are arrayed in correspondence with the digital information;
a marker to search for a reading reference point of each dot on the data dot pattern; and
a block address pattern to identify each block.

11. An information processing method comprising:
obtaining a script by optically reading an optically readable coded image from an information recording medium which includes a portion where digital information is recorded as the optically readable coded image obtained by encoding the digital information, the digital information containing the script to designate an object associated with an information processing apparatus which processes digital information obtained by optically reading and decoding the coded image and to perform at least one of processing and control; and
analyzing the obtained script and performing the at least one of processing and control.

12. A method according to claim 11, wherein the digital information contains the script in a file form.

13. A method according to claim 11, wherein the object includes a data file.

14. A method according to claim 11, wherein the object includes a program.

15. A method according to claim 11, wherein the object includes at least one of an internal device of the information processing apparatus and an external device connected to the information processing apparatus.

16. A method according to claim 11, wherein the digital information further contains data used for the at least one of processing and control.

17. A method according to claim 11, wherein the script is so described as to acquire predetermined information from the object in order to perform the at least one of processing and control for the designated object.

18. A method according to claim 11, wherein the coded image can be manually read.

19. A method according to claim 18, wherein
the coded image is formed by arraying a plurality of blocks, and
each block includes:
a data dot pattern on which dots are arrayed in correspondence with the digital information;
a marker to search for a reading reference point of each dot on the data dot pattern; and
a block address pattern to identify each block.

20. An information processing apparatus comprising:
a reader which optically reads an optically readable coded image from an information recording medium which includes a portion where digital information is recorded as the optically readable coded image obtained by encoding the digital information, the digital information containing a script to designate an object associated with said information processing apparatus which processes digital information obtained by optically reading and decoding the coded image and to perform at least one of processing and control;
a decoder which obtains an original script from the coded image read by said reader; and
an information processor which analyzes the script obtained by said decoder and performs the at least one of processing and control.

21. An apparatus according to claim 20, wherein the digital information contains the script in a file form.

22. An apparatus according to claim 20, wherein the object includes a data file.

23. An apparatus according to claim 20, wherein the object includes a program.

24. An apparatus according to claim 20, wherein the object includes at least one of an internal device of said information processing apparatus and an external device connected to said information processing apparatus.

25. An apparatus according to claim 20, wherein the digital information further contains data used for the at least one of processing and control.

26. An apparatus according to claim 20, wherein the script is so described as to acquire predetermined information from the object in order to perform the at least one of processing and control for the designated object.

27. An apparatus according to claim 20, wherein said information processing apparatus is constituted integrally with said reader to optically read the coded image.

28. An apparatus according to claim 20, wherein said information processing apparatus is constituted separately from said reader to optically read the coded image.

29. An apparatus according to claim 20, wherein the coded image can be manually read.

30. An apparatus according to claim 29, wherein
the coded image is formed by arraying a plurality of blocks, and
each block includes:
a data dot pattern on which dots are arrayed in correspondence with the digital information;
a marker to search for a reading reference point of each dot on the data dot pattern; and
a block address pattern to identify each block.

31. A program to cause a computer to realize following functions, comprising:
a function of obtaining a script by optically reading an optically readable coded image from an information recording medium which includes a portion where digital information is recorded as the optically readable coded image obtained by encoding the digital information, the digital information containing the script to designate an object associated with an information processing apparatus which processes digital information obtained by optically reading and decoding the coded image and to perform at least one of processing and control; and
a function of analyzing the obtained script and performing the at least one of processing and control.

32. A program according to claim 31, wherein the digital information contains the script in a file form.

33. A program according to claim 31, wherein the object includes a data file.

34. A program according to claim 31, wherein the object includes a program.

35. A program according to claim 31, wherein the object includes at least one of an internal device of the information processing apparatus and an external device connected to the information processing apparatus.

36. A program according to claim 31, wherein the digital information further contains data used for the at least one of processing and control.

37. A program according to claim 31, wherein the script is so described as to acquire predetermined information from the object in order to perform the at least one of processing and control for the designated object.

38. A program according to claim 31, wherein the coded image can be manually read.

39. A program according to claim 38, wherein
the coded image is formed by arraying a plurality of blocks, and each block includes:
a data dot pattern on which dots are arrayed in correspondence with the digital information;
a marker to search for a reading reference point of each dot on the data dot pattern; and
a block address pattern to identify each block.
